(19) United States
(12) Patent Application Publication
(10) Pub. No.: US 2004/0113762 A1
(43) Pub. Date: Jun. 17, 2004

(54) Multi-functional car-burglar-proof annunciator

(76) Inventor: Chen-Kuei Hsieh, Chung-Li City (TW)

Correspondence Address: Keith Kline, PRO-TECHTOR INTERNATIONAL SERVICES, 20775 Norada Court, Saratoga, CA, 95070-3018, US

(21) Appl. No.: 10/317,781

(22) Filed: Dec. 11, 2002

(51) Int. Cl. B60R 25/10

(52) U.S. Cl. 340/426.31

(57) ABSTRACT

A multi-functional car-burglar-proof annunciator is disclosed. A lock body has a long rod. The long rod has a lock head and a lock kernel portion. A front end of the lock body has a protruded locking seat for fixing the circuit elements of the burglar-proof annuniator. The burglar-proof annuniator in the lock body includes at least one independent battery unit as a power supply of the burglar-proof annuniator; a burglar-proof detecting unit for detecting the intrusion condition and to trigger the main control unit of the burglar-proof annuniator; an alarm unit for trigger a strong voice or flash; and a wireless signal transmission unit. A far-reaching alerting device capable includes at least one wireless signal receiving unit for receiving the signals from the burglar-proof annuniator; a control unit for decoding the signal; a mobile phone dialing control unit; and a mobile phone communication unit.

### FIELD OF THE INVENTION

The present invention relates to a multi-functional car-burglar-proof annunciator, wherein a lock has a battery for supplying power to the burglar-proof annuniator; the burglar-proof annuniator can emit wireless signals to a far-reaching alerting device. Thereby, the condition can be informed to the user wirelessly.

### BACKGROUND OF THE INVENTION

In the prior art, mechanic lock, such as locks locking the steering wheel, or the gears, etc., are developed for burglar-proof. However, these ways only delay the time period that the vehicle is stolen

Thereby, electronic burglar-proof devices are developed. These devices are connected to the battery of the car. In operation, a detector serves to detect the condition of the car. When an emergency occurs, voices are emitted to threat the burglars. However, this prior art device has a power supply from the battery of a car. Moreover, in the prior art, the burglar-proof lock and the burglar-proof annuniator are independently installed. The user must buy the two independently. The cost is high. Furthermore, the burglar-proof annuniator emits voice due to outer vibration (such as thunderbolt, passing of a large car, etc.) so as to interfere the unrelated people.

### SUMMARY OF THE INVENTION

Accordingly the primary object of the present invention is to provide a multi-functional car-burglar-proof annunciator; wherein a lock body has a long rod; the long rod has a lock head and a lock kernel portion; a front end of the lock body has a protruded locking seat for fixing the circuit elements of the burglar-proof annuniator. The burglar-proof annuniator in the lock body includes at least one independent battery unit as a power supply of the burglar-proof annuniator; a burglar-proof detecting unit for detecting the intrusion condition and to trigger the main control unit of the burglar-proof annuniator; an alarm unit for trigger a strong voice or flash under the control of the main control unit; and a wireless signal transmission unit for sending alarm signal to the far-reaching alerting device; and a far-reaching alerting device capable of being installed independently from the burglar-proof annuniator includes at least one wireless signal receiving unit for receiving the signals from the burglar-proof annuniator; a control unit for receiving the burglar-proof alarm signal and decoding the signal; a mobile phone dialing control unit controlled by the main control unit; and a mobile phone communication unit.

In the present invention, a signal adaptor is installed between the mobile phone dialing control unit and the mobile phone communication unit so that the mobile phone communication unit can be assembled to or detached from the far-reaching alerting device.

Moreover, the mobile phone dialing control unit 34 may be set with at least one phone number for informing emergency conditions to those needing the messages.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 shows one embodiment of the present invention.

FIG. 3 shows the functional block diagram of the burglar-proof annuniator of the present invention, which is installed to a lock.

FIG. 4 is a circuit diagram of the burglar-proof annuniator of the present invention, wherein the burglar-proof annuniator is installed to a lock.

FIG. 5 is a functional block diagram of the far-reaching alerting device of the present invention.

FIG. 6 shows the circuit diagram of the far-reaching alerting device of the present invention.

### DETAILED DESCRIPTION OF THE INVENTION

As shown in the figures, the multi-functional car-burglar-proof annunciator of the present invention is illustrated. The multi-functional car-burglar-proof annunciator includes a lock with a burglar-proof annuniator and a far-reaching alerting device matching to the burglar-proof annuniator.

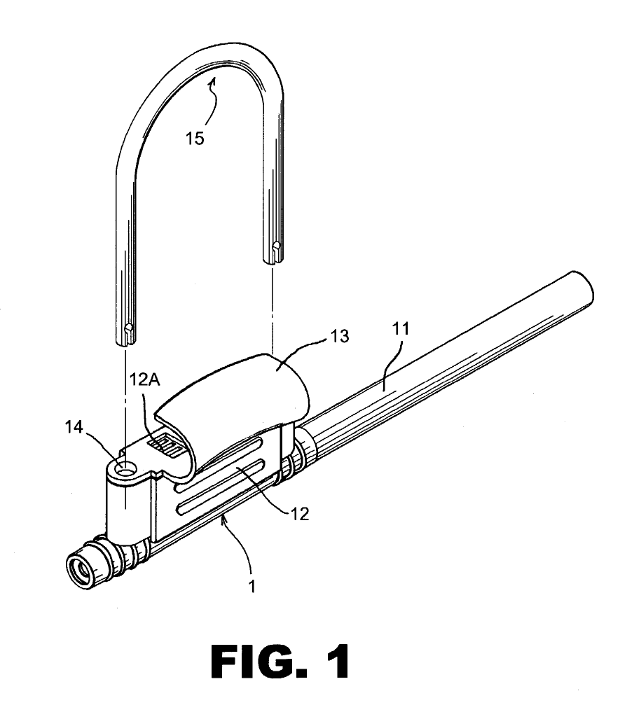

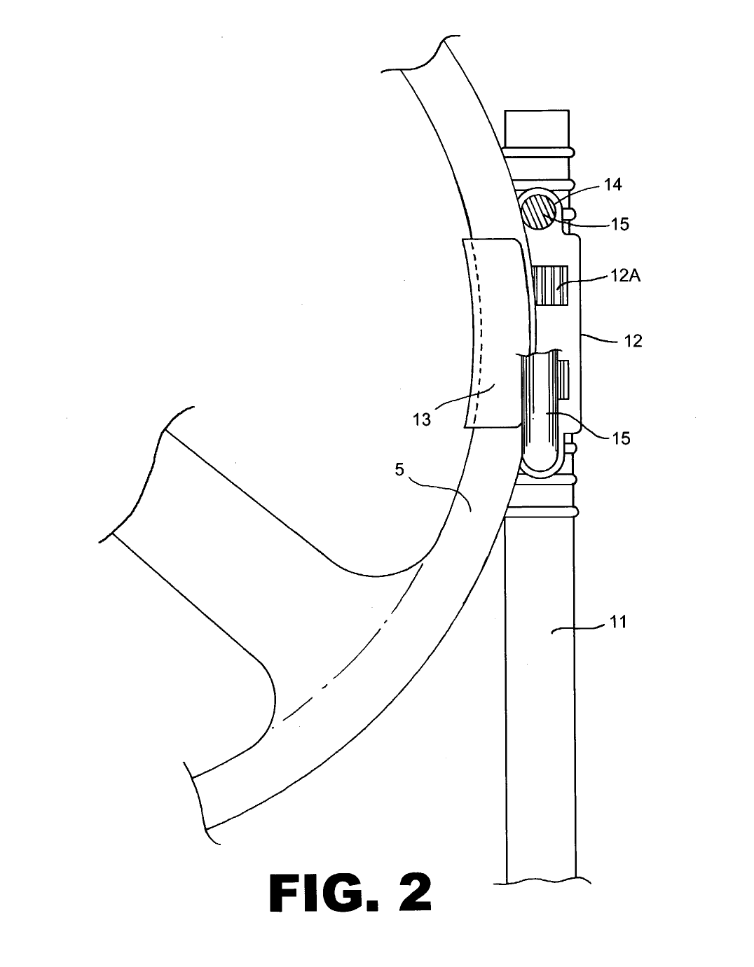

Referring to FIGS. 1 and 2, the lock body is used in the prior art. The lock body 1 has a long rod 11. The long rod 11 has a lock head, a lock kernel portion, etc. (not shown). A front end of the lock body 1 has a protruded locking seat 12 for fixing the circuit elements of the burglar-proof annuniator 2. A top of the locking seat 12 has a buckle 13 with a C shape cross section. Each of two sides of the locking seat 12 has an inserting hole 14 for beings inserted by a stud 15.

In locking, the buckle 13 is installed to a steering wheel handle 5. Two pins of the stud 15 are buckled into the inserting hole 14. Therefore, the locking body 1 is steadily locked to the steering wheel handle 5. By the long rod 11 at a distal end of the lock body 1 to protrude out of the steering wheel handle 5, the operation of the steering wheel is interrupted so as to achieve the object of burglar-proof. When the lock is in burglar-proof condition. The burglar-proof annuniator 2 in the locking seat 12 of the lock body will operate. If the lock detects that abnormal vibrations or the variation of air pressure, the burglar-proof annuniator 2 will emit voice to threat the burglars. Meanwhile, the burglar-proof signals will trigger the far-reaching alerting device 3.

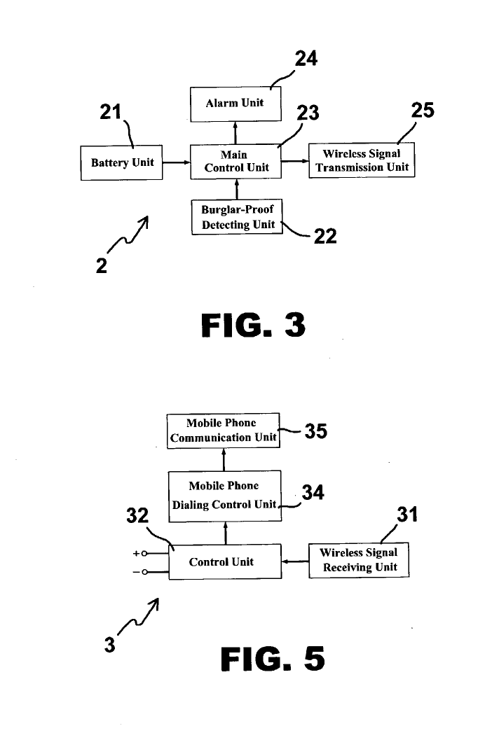

Referring to FIGS. 3 and 4, the burglar-proof annuniator 2 in the lock body includes at least one independent battery unit 21 as a power supply of the burglar-proof annuniator 2; a burglar-proof detecting unit 22 for detecting the intrusion condition and to trigger the main control unit 23 of the burglar-proof annuniator 2; an alarm unit 24 for trigger a strong voice (or flash) under the control of the main control unit 23; and a wireless signal transmission unit 25 for sending alarm signal to the far-reaching alerting device 3.

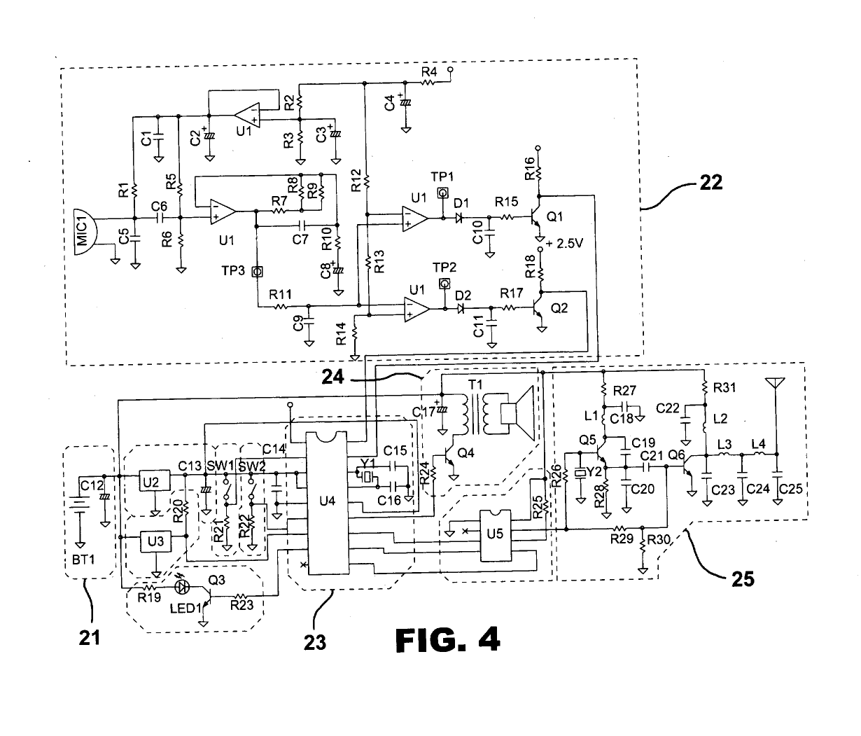

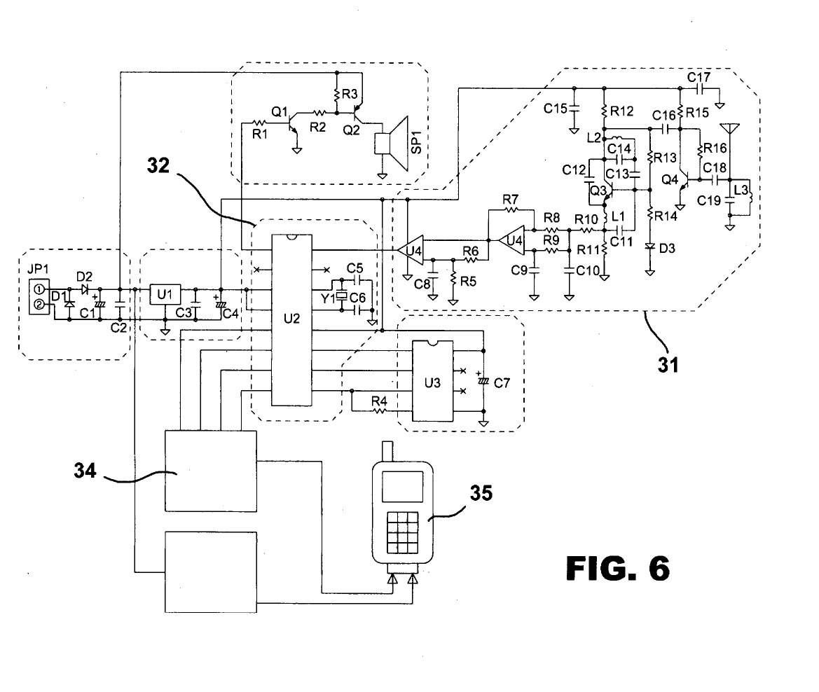

Referring to FIGS. 5 and 6, a far-reaching alerting device 3 capable of being installed independently from the burglar-proof annuniator 2 includes at least one wireless signal receiving unit 31 for receiving the signals from the burglar-proof annuniator 2; a control unit 32 for receiving the burglar-proof alarm signal and decoding the signal; a mobile phone dialing control unit 34 controlled by the main control unit 23; and a mobile phone communication unit 35.

The far-reaching alerting device 3 can be hidden at any place of a vehicle so as to avoid to be destroyed. Preferably, a signal adaptor is installed between the mobile phone dialing control unit 34 and the mobile phone communication unit 35 so that the mobile phone communication unit 35 may be assembled to or detached from the far-reaching alerting device 3. Thereby, the far-reaching alerting device 3 can be updated with different mobile phones. The mobile phone dialing control unit 34 may be set with at least one phone number for informing emergency conditions to those needing the messages.

The multi-functional car-burglar-proof annunciator is formed by a lock body 1, a burglar-proof annuniator 2 and a far-reaching alerting device 3. The steering wheel handle 5 of the burglar-proof annuniator 2 will stop the operation of the steering wheel. If the vehicle is destroyed by outer force or the pressure within the vehicle is changed greatly, the burglar-proof annuniator 2 will generate a strong voice to threat burglars. Moreover, signals are emitted to trigger the far-reaching alerting device 3 so as to inform the user.

The burglar-proof annuniator 2 of the lock is installed to a box body 12 and is protected by a concrete locking seat 12. The battery unit 21 supplies power to the burglar-proof annuniator 2 so as to avoid that the outer power supply is interrupted. The burglar-proof annuniator 2 and the far-reaching alerting device 3 are operated independently. Therefore, the installations of the components are simple and quick. Thus the cost is reduced greatly.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A multi-functional car-burglar-proof annunciator; wherein a lock body has a long rod; the long rod has a lock head and a lock kernel portion; a front end of the lock body has a protruded locking seat for fixing the circuit elements of the burglar-proof annuniator; characterized in that:
the burglar-proof annuniator in the lock body includes at least one independent battery unit as a power supply of the burglar-proof annuniator; a burglar-proof detecting unit for detecting the intrusion condition and to trigger the main control unit of the burglar-proof annuniator; an alarm unit for trigger a strong voice or flash under the control of a main control unit; and a wireless signal transmission unit for sending alarm signal to the far-reaching alerting device; and
a far-reaching alerting device capable of being installed independently from the burglar-proof annuniator includes at least one wireless signal receiving unit for receiving the signals from the burglar-proof annuniator; a control unit for receiving the burglar-proof alarm signal and decoding the signal; a mobile phone dialing control unit controlled by the main control unit; and a mobile phone communication unit.

2. The multi-functional car-burglar-proof annunciator as claim in claim 1, wherein a signal adaptor is installed between the mobile phone dialing control unit and the mobile phone communication unit so that the mobile phone communication unit can be assembled to or detached from the far-reaching alerting device.

3. The multi-functional car-burglar-proof annunciator as claim in claim 1, wherein the mobile phone dialing control unit is set with at least one phone number for informing emergency conditions to those needing the messages.
